(19) United States
(12) Patent Application Publication
(10) Pub. No.: US 2011/0073724 A1
(43) Pub. Date: Mar. 31, 2011

(54) Foldable supporting stand

(75) Inventor: Jung-Huo CHEN, Taichung (TW)

(73) Assignee: REXON INDUSTRIAL CORP., LTD., Taichung (TW)

(21) Appl. No.: 12/882,630

(22) Filed: Sep. 15, 2010

(30) Foreign Application Priority Data
Sep. 30, 2009 (TW) 098133216

(51) Int. Cl. F16M 11/38

(52) U.S. Cl. 248/176.3

(57) ABSTRACT

A foldable supporting stand includes a hub having a center axis, a foot member unit pivotally connected to the hub, and multiple supporting bars each having one connecting end respectively pivotally connected to the hub. The stand includes multiple positioning mechanisms adapted for securing the supporting bars to the hub respectively. When the foldable supporting stand is set in a collapsed non-operative position, the foot member unit and the supporting bars are maintained in close alignment to the center axis of the hub. When the foldable supporting stand is set in an extended operative position, the supporting ends of the supporting bars are aligned in a single plane to provide a supporting plane, and the foot member unit supports the hub above the floor.

This application claims, under 35 U.S.C. §119, priority to Taiwanese Application No. 098133216, filed Sep. 30, 2009, which application is hereby incorporated by reference in its entirety, inclusive of the specification, claims, and drawings.

### FIELD OF THE INVENTION

The present disclosure relates to a supporting stand and more particularly, to a foldable supporting stand.

### BACKGROUND

Regular power tools are generally classified in two types, namely, a stationary type and a bench top type. Normally, a stationary power tool has a relatively larger size, and must be positioned on the floor during use, while a bench top power tool has a relatively smaller size, and is configured for placement on a certain height of table or supporting stand for easy operation by an operator.

A bench top tool is more convenient than a stationary tool for movement from one workplace to another. A user may have to move a bench top tool from one workplace to another to satisfy different application requirements. However, when a table is unavailable, a supporting stand must be used and moved together with the bench top power tool. To assure supporting stability, conventional power tool supporting stands are commonly designed to be quite heavy and thus, sturdy. If such a power tool supporting stand is not foldable, it will be difficult to move and store such a stand when the stand is not in use.

### SUMMARY

The present disclosure has been accomplished under the circumstances in view. Accordingly, embodiments of the present disclosure provide a foldable supporting stand, which facilitates folding and elevation adjustment and is practical for steadily supporting a bench top power tool thereon.

In particular, a foldable supporting stand is settable between an extended operative position and a collapsed non-operative position. The foldable supporting stand includes a hub having a center axis, a foot member unit pivotally connected to the hub, and multiple supporting bars each having one connecting end respectively pivotally connected to the hub. The foldable supporting stand includes multiple positioning mechanisms adapted for securing the supporting bars to the hub respectively.

When the foldable supporting stand is set in the collapsed non-operative position, the foot member unit and the supporting bars are maintained close to the center axis of the hub. When the foldable supporting stand is set in the extended operative position, the opposed supporting ends of the supporting bars are positioned in a single plane to provide a supporting plane, and the foot member unit supports the hub above the floor.

Thus, when collapsed, the foldable supporting stand occupies less space and is convenient for storage, carrying and delivery.

### BRIEF DESCRIPTION OF THE DRAWINGS

FIG. 1 is an elevational front view of a foldable supporting stand in accordance with a first embodiment of the present disclosure.

FIG. 2A is a schematic plain view showing the foldable supporting stand of FIG. 1 in the collapsed configuration.

FIG. 2B is a schematic plain view showing the foldable supporting stand of FIG. 1 in the extended configuration.

FIG. 3A is a schematic plain view of a part of a foldable supporting stand in accordance with a second embodiment of the present disclosure, showing the arrangement between each supporting bar and the associated positioning mechanism.

FIG. 3B corresponds to FIG. 3A, showing the angular position of the supporting bar in an adjusted position.

FIG. 4A is a schematic exploded view of a part of a foldable supporting stand in accordance with a third embodiment of the present disclosure, showing the arrangement between each supporting bar and the associated positioning mechanism.

FIG. 4B corresponds to FIG. 4A, showing the supporting bar secured to the hub in one selected angular position.

FIG. 5A is a schematic applied view of the first embodiment of the present disclosure, showing a power tool supported on the foldable supporting stand.

FIG. 5B illustrates the collapsed configuration of the foldable supporting stand in accordance with the first embodiment of the present disclosure.

### DETAILED DESCRIPTION

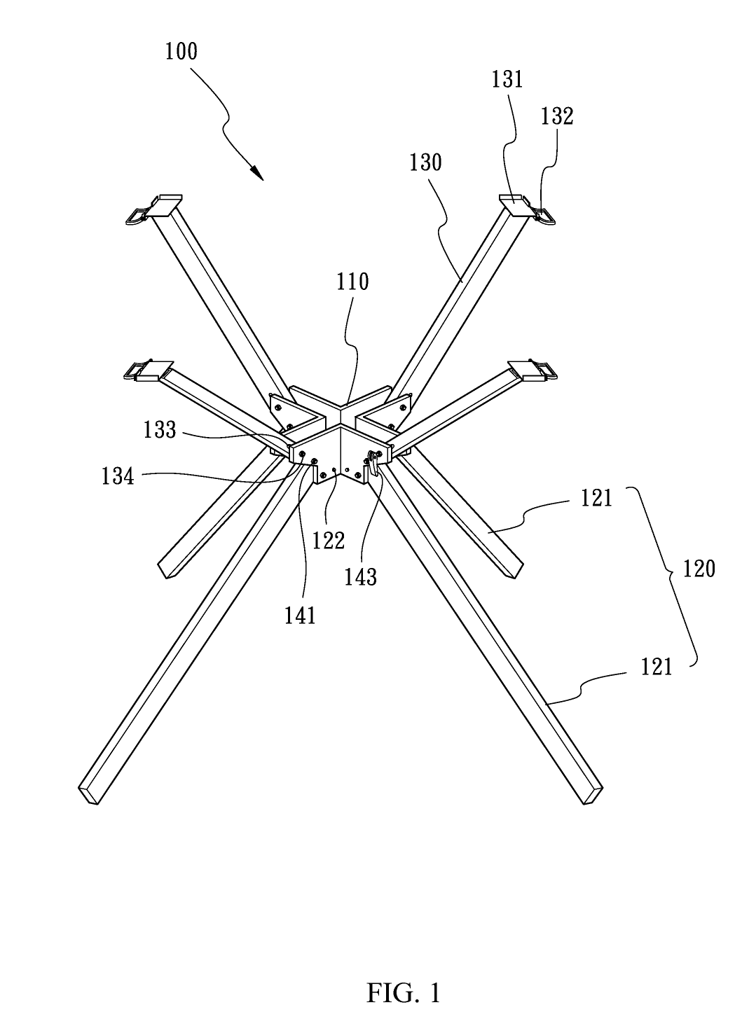

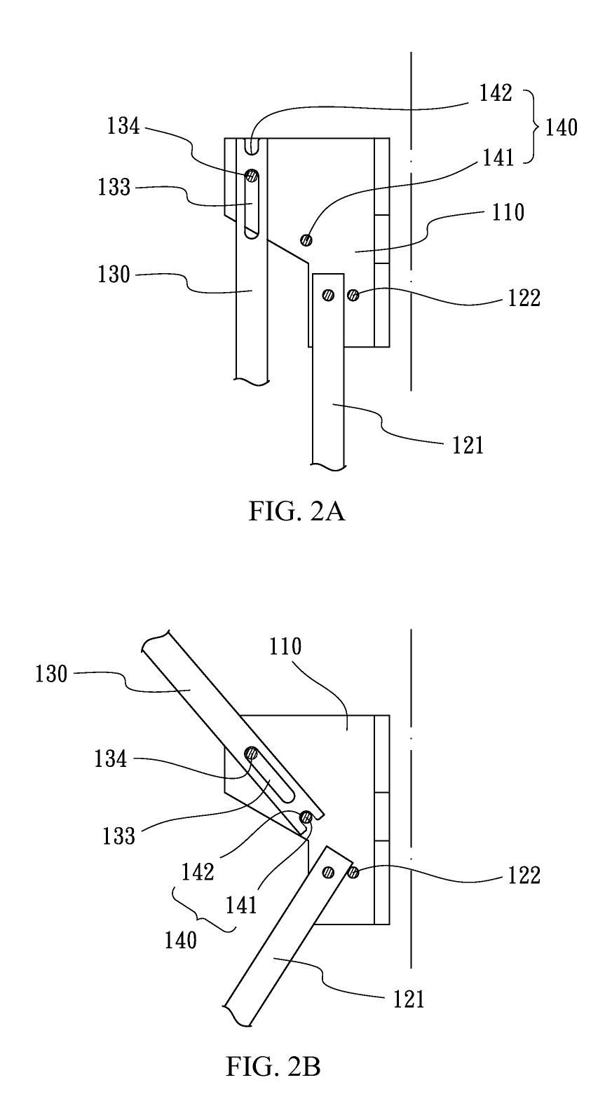

Turning first to FIGS. 1, 2A and 2B, as particularly shown in FIG. 1, the foldable supporting stand 100 comprises a hub 110, a foot member unit 120, four supporting bars 130 and four positioning mechanisms 140. The foot member unit 120 includes four foot bars 121 respectively pivotally connected to the hub 110 for supporting the hub 110 above the floor. The supporting bars 130 each have one connecting end pivotally connected to the hub 110 and the other opposed supporting end terminating in a locating plate 131. As shown in FIG. 2A, the four positioning mechanisms 140 are located on the hub 110 and adapted for locking the supporting bars 130 to the hub 110.

The hub 110 is a radially extended hollow block member, having a crossed, X-shaped or Y-shaped profile. Thus, the four ends of the radially extended hollow block member of the hub 110, when viewed from the top or bottom side, can constitute a multilateral plane, for example, a square plane, non-square plane, or triangular plane. Because most conventional power tools have a rectangular shape, the four ends of the radially extended hollow block member of the hub 110 preferably constitute a non-square plane for a better fit for such rectangular shaped power tools.

As stated above, the foot member unit 120 includes four foot bars 121. Each foot bar 121 has one connecting end pivotally connected to the hub 110 and an opposed supporting end configured to engage a supporting surface (such as the floor) in order to support the hub 110 above the supporting surface. Before the use of the foldable supporting stand 100, the foot bars 121 can be moved toward the center axis of the hub 110 to a collapsed position where the foot bars 121 are aligned and maintained in parallel to the center axis of the hub 110; when in use, the foot bars 121 are radially outwardly rotated away from the center axis of the hub 110 to an extended position.

The hub 110 is provided with four stop members 122 that can be in the form of pins or stop blocks adapted for stopping movement of the foot bars 121 in order to limit the maximum angle through which the foot bars 121 can turn, thus enabling the foot bars 121 to support the hub 110 steadily above the floor.

As stated above, each supporting bar 130 has one connecting end pivotally connected to the hub 110. The location of the pivot connection between each supporting bar 130 and the hub 110 is positioned above the location of the pivot connection between each foot bar 121 and the hub 110.

When not in use, the supporting bars 130 are rotated downwards toward the center axis of the hub 110 and maintained substantially in parallel to the center axis of the hub 110. When in use, the supporting bars 130 are rotated upwards to an extended position above the elevation of the hub 110, thus positioning the locating plates 131 in a single plane for supporting a power tool. The locating plate 131 of each supporting bar 130 has a locking lever 132 disposed at one lateral side for locking the locating plate 131 to the supported power tool, in order to avoid accidental separation of the power tool from the foldable supporting stand 100 during operation.

As shown in FIG. 2A, when the foldable supporting stand 100 is not in use, the foot bars 121 of the foot member unit 120 and the supporting bars 130 and maintained in the downwardly extended collapsed position in a substantially parallel manner. Thus, when collapsed, the foldable supporting stand 100 occupies less space and is convenient for storage, carrying, and delivery.

Referring to FIG. 2B, each supporting bar 130 has a longitudinal sliding slot 133 disposed adjacent to the connecting end remote from the opposed supporting end carrying the locating plate 131, the sliding slot 133 coupled to one respective pivot pin 134 in the hub 110. Each positioning mechanism 140 comprises a male positioning member 141 located on the hub 110, and a female positioning member 142 located on the connecting end of one supporting bar 130. The male positioning member 141 can be a pin or bolt fixedly fastened to the hub 110. The female positioning member 142 can be a notch formed on the connecting end of one supporting bar 130.

When the user turns the supporting bars 130 upwards to a predetermined height, the supporting bars 130 can be axially moved along the sliding slot 133 toward the respective male positioning members 141 to force the respective female positioning members 142 into engagement with the respective male positioning members 141, thereby holding the supporting bars 130 in the extended position.

Each positioning mechanism 140 further comprises a quick-release device 143 (shown in FIG. 1) inserted through the hub 110 and a respective supporting bar 130. When one supporting bar 130 is held at the predetermined height by the respective positioning mechanism 140, the user can operate the respective quick-release device 143 to lock down the supporting bar 130. Thus, before rotating the respective supporting bar 130, the user must release the quick-release device 143. The quick-release devices 143 of the positioning mechanisms 140 can be respectively coaxially mounted with the pivot pins 134. After the supporting bars 130 have been set in position by the respective positioning mechanisms 140, the quick-release devices 143 are operated to lock the supporting bars 130 by a clamping action on the respective supporting bars 130 between flanged portions of the hub 110.

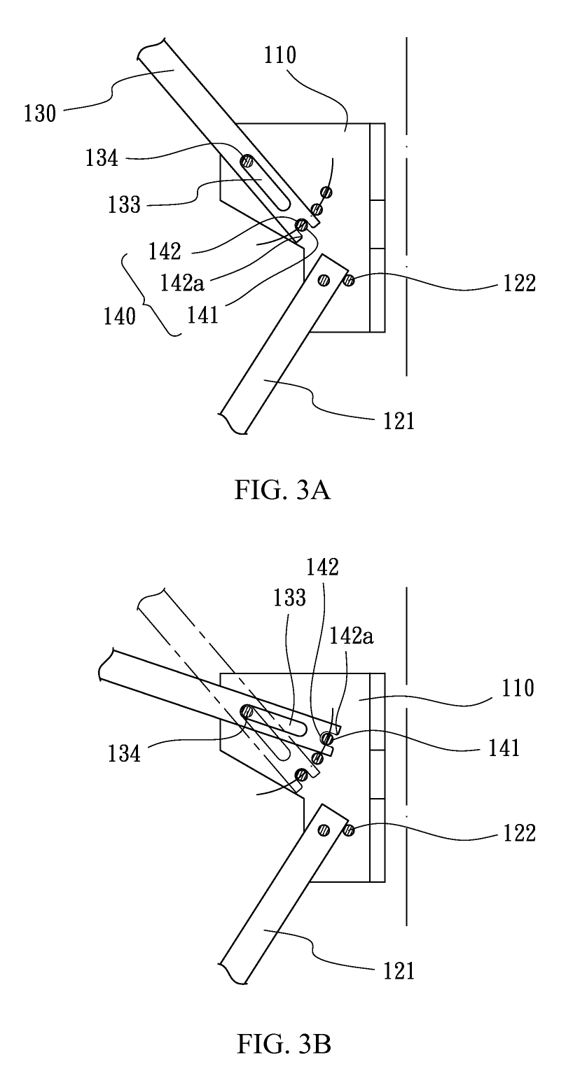

Referring to FIG. 3A, in a foldable supporting stand in accordance with a second embodiment of the present disclosure, each positioning mechanism 140 includes three male positioning members 141 that are fixedly mounted in the hub 110.

Referring to FIGS. 3A and 3B, the female positioning member 142 of each positioning mechanism 140 that is located on the connecting end of one supporting bar 130 can be selectively moved into engagement with one of the three male positioning members 141 of the respective positioning mechanism 140 to hold the respective supporting bar 130 in one of three different angular positions, i.e., the supporting bars 130 can be adjusted subject to the size of the power tool to be supported. Thus, the applicability of the foldable supporting stand 100 for different sized power tools is enhanced.

Further, the female positioning member (notch) 142 of each positioning mechanism 140 has a chamfered edge 142a that smoothly guides the respective female positioning member (notch) 142 into engagement with one of the three male positioning members 141, avoiding friction between the male positioning member 141 and the female positioning member (notch) 142 and enhancing their durability.

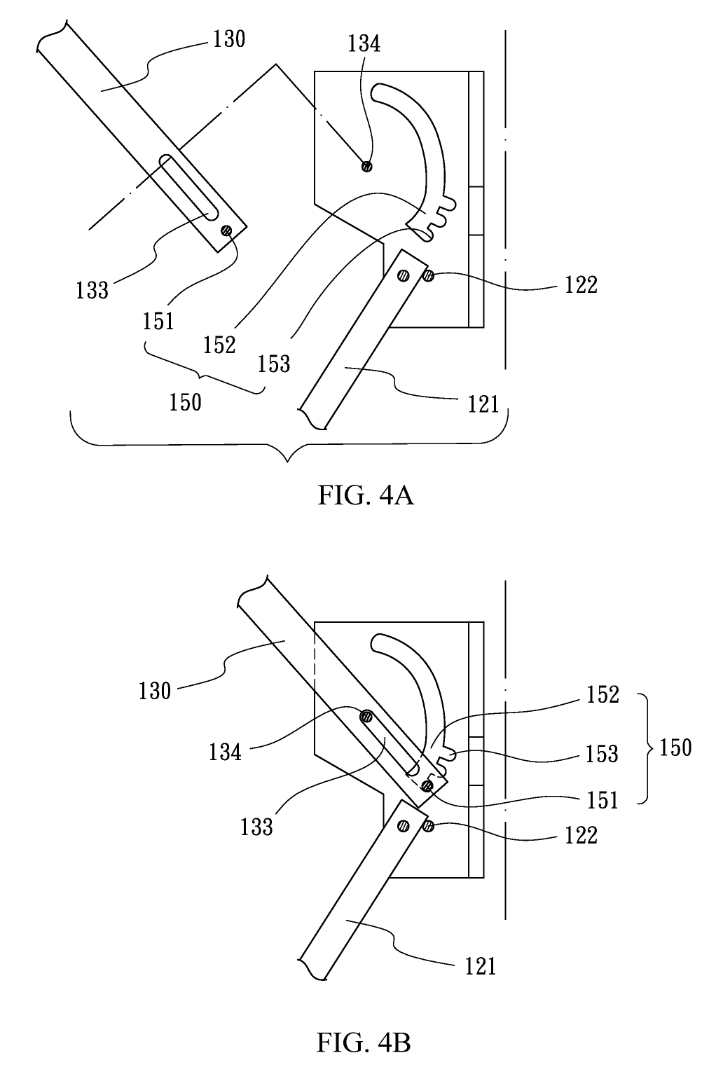

Referring to FIG. 4A, in a foldable supporting stand in accordance with a third embodiment of the present disclosure, each positioning mechanism 150, includes a male positioning member 151 that is fixedly mounted on the connecting end of one supporting bar 130 adjacent to the longitudinal sliding slot 133 of the supporting bar 130, and a female positioning member 152 located on the hub 110.

The female positioning member 152 is a smoothly arced sliding slot located on the hub 110, having three locating grooves 153 perpendicularly extended from the axis of the slot on one side thereof. The male positioning member 151 is a pin or bolt inserted through and movable along the smoothly arced sliding slot of the female positioning member 152, and can be selectively engaged into one of the three locating grooves 153.

Referring to FIGS. 4A and 4B, the male positioning member 151 that is fixedly mounted on the connecting end of one supporting bar 130 can be selectively moved into engagement with one of the three locating grooves 153 of the female positioning member 152 to hold the respective supporting bar 130 in one of three different angular positions, i.e., the supporting bars 130 can be adjusted subject to the size of the power tool to be supported.

To adjust the angular position of each supporting bar 130, the supporting bar 130 is pulled axially backwardly relative to the hub 110 to move the longitudinal sliding slot 133 relative to the associated pivot pin 134 and to disengage the male positioning member 151 from the respective locating groove 153 Next, the supporting bar 130 is rotated about the associated pivot pin 134 to move the male positioning member 151 along the smoothly arced sliding slot of the female positioning member 152, and then the supporting bar 130 is slid axially forwardly relative to the hub 110 to move the male positioning member 151 into another locating groove 153 of the female positioning member 152.

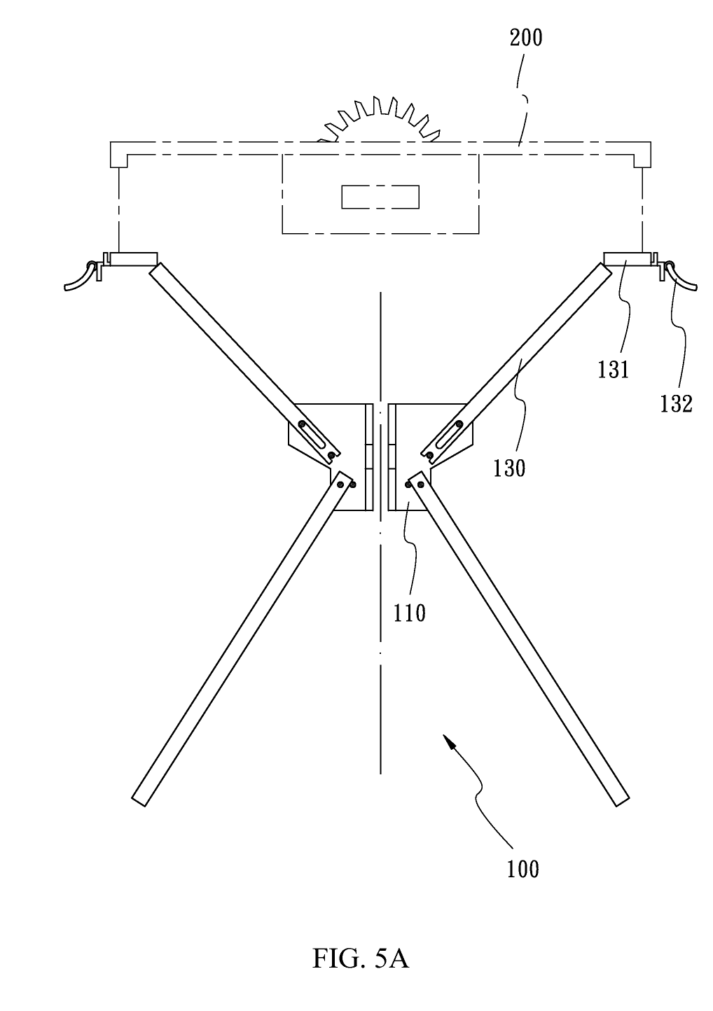

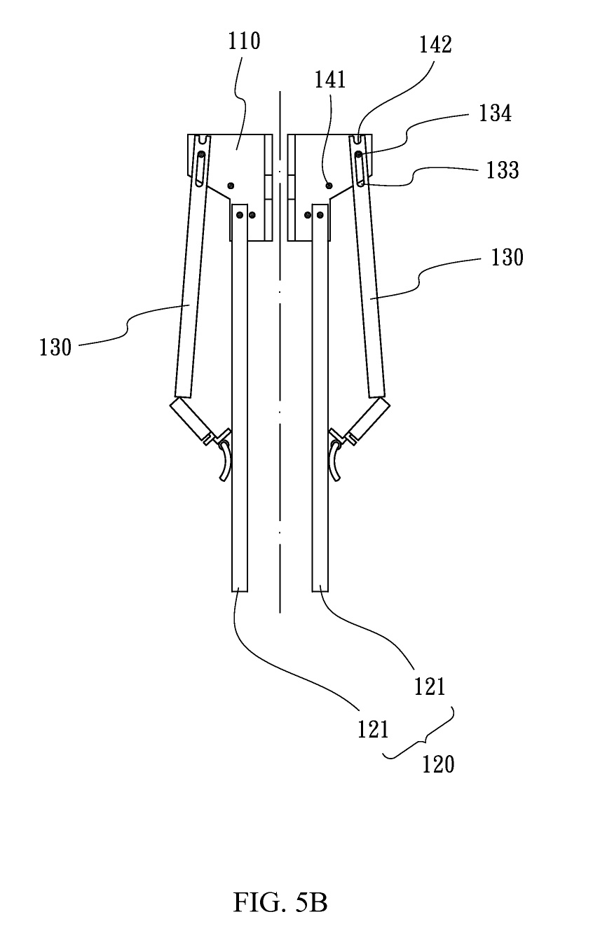

FIG. 5A illustrates an application example of the foldable supporting stand 100 in accordance with the first embodiment of the present disclosure. When a power tool 200 is supported on the locating plates 131 of the supporting bars 130, the locking levers 132 are operated to lock the locating plate 131 to the supported power tool 200, in order to avoid accidental separation of the power tool 200 from the foldable supporting stand 100 due to vibrations produced during operation of the power tool 200.

Referring to FIG. 5B, when the female positioning members (notches) 142 are disengaged from the male positioning members 141, the supporting bars 130 and the foot bars 121 are turned downwards toward the center axis of the hub 110 and maintained in a substantially parallel manner convenient for carrying, storage, or delivery of the stand 100.

As discussed above, by way of adjusting the angular position of the supporting bars 130, the foldable supporting stand can support different sizes of power tools at different elevations to fit different application requirements.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A foldable supporting stand, comprising:
a hub having a center axis;
a foot member unit pivotally connected to said hub;
at least three supporting bars each having a connecting end thereof pivotally connected to said hub; and
at least three positioning mechanisms adapted for securing said supporting bars to said hub respectively;
wherein when said foldable supporting stand is set in a collapsed non-operative position, said foot member unit and said supporting bars are maintained in close alignment with said center axis of said hub; and when said foldable supporting stand is set in an extended operative position, the connecting ends of said supporting bars pivotally connected to said hub are secured by said at least three positioning mechanisms, and opposed supporting ends of said supporting bars are aligned in a single plane to provide a supporting plane, and said foot member unit supports said hub above the floor.

2. The foldable supporting stand according to claim 1, further comprising:
a longitudinal sliding slot located on each said supporting bar; and
a pivot pin inserted through the longitudinal sliding slot on each said supporting bar and affixed to said hub to connect each said supporting bar to said hub for enabling each said supporting bar to be moved axially relative to said hub and rotated about the associated pivot pin.

3. The foldable supporting stand according to claim 2, wherein each said positioning mechanism comprises:
at least one male positioning member located on said hub; and
a female positioning member located on the connecting end of one said supporting bar and adapted for engaging said at least one male positioning member.

4. The foldable supporting stand according to claim 2, wherein each said positioning mechanism comprises:
a female positioning member in the form of a smoothly arced sliding slot located on said hub and having a plurality of locating grooves perpendicularly extended from one side thereof; and
a male positioning member located on the connecting end of one said supporting bar and inserted through and movable with the associated supporting bar along said smoothly arced sliding slot of said female positioning member and selectively engageable into one of the plurality of locating grooves.

5. The foldable supporting stand according to claim 1, wherein said foot member unit comprises three foot bars respectively pivotally connected to said hub.

6. The foldable supporting stand according to claim 5, further comprising three stop members located on said hub and adapted for stopping said foot bars to limit an adjustment angle of said foot bars relative to said hub.

7. The foldable supporting stand according to claim 1, further comprising at least three quick-release devices mounted in said hub and said supporting bars and adapted for locking said supporting bars to said hub.

8. The foldable supporting stand according to claim 1, wherein each said supporting bar has a locating plate disposed at the opposed supporting end thereof.

9. The foldable supporting stand according to claim 1, wherein said hub is a radially extended hollow block member, having a crossed, X-shaped, or Y-shaped profile.

10. The foldable supporting stand according to claim 9, wherein said hub has a crossed or X-shaped profile; and the number of said supporting bars and the number of said positioning mechanisms are four.
